(19) United States
(12) Patent Application Publication
(10) Pub. No.: US 2003/0091272 A1
(43) Pub. Date: May 15, 2003

(54) Thermally stable optical-fiber switch

(76) Inventors: Susanne Sigloch, Mainz (DE); Michel Neumeier, Mandelbachtal (DE); Jens Hossfeld, Rosbach v.d.H. (DE)

Correspondence Address: PEARNE & GORDON LLP, 526 SUPERIOR AVENUE EAST, SUITE 1200, CLEVELAND, OH, 44114-1484, US

(21) Appl. No.: 10/169,690

(22) PCT Filed: Jan. 2, 2001
(86) PCT No.: PCT/EP01/00006

(30) Foreign Application Priority Data
Jan. 7, 2000 (DE) 100 00 482.2

(51) Int. Cl. G02B 6/35

(52) U.S. Cl. 385/22; 385/16

(57) ABSTRACT

A fiber-optic switch has a fiber-optic switching element in which an adjustment structure (8) is used for positioning of at least one moving fiber (1) by means of a switching body (2c) in front of at least one fiber (4, 6), which is arranged in a fixed position, by means of reference surfaces (3a, 3b, 5a, 5b) , in which case both the moving fiber (1) and the fibers (4, 6) which are arranged in fixed positions are held such that they can be moved longitudinally within the adjustment structure but rest on the reference surfaces (3a, 3b, 5a, 5b), and a mount (11) with a thermal coefficient of expansion which is comparable to that of the fibers (1, 4, 6) holds the adjustment structure (8) and fixes both the moving fiber (1) and the fibers (4, 6) which are arranged in fixed positions longitudinally, at least as far as their effect is concerned.

### DESCRIPTION

The invention relates to a thermally stable fiber-optic switch and to a fiber-optic switch component which comprises one or more fiber-optic switches. In particular, the invention relates to a fiber-optic switching element for a thermally stable fiber-optic switch, in which at least one moving light guide fiber is positioned in front of at least one light guide fiber that is arranged in a fixed position.

In a fiber-optic 1×2 switching element as described by way of example, a moving light guide fiber, which is referred to for the sake of simplicity as a fiber in the following text, is generally positioned, by a switching body and by means of an adjustment structure, either in front of a first light guide fiber, which is arranged in a fixed position, or in front of a second light guide fiber, which is arranged in a fixed position, with there being a gap between the positioned moving fiber and a respective fiber which is arranged in a fixed position. For this purpose, the fibers are clamped in the switch, in which case the gap between the optical fibers changes in response to temperature changes, due to the different coefficients of expansion of the switch body and fiber.

WO88/02869 discloses an optical switch in which a moving fiber is firmly connected to a switching body, by means of which it can be guided with respect to one of two V-shaped stop surfaces, on each of which a fiber which is arranged in a fixed position rests. Mechanical stops are provided in order to limit the movement of the switching body, and are arranged such that the optical fiber closely adjoins the respective V-shaped stop by virtue of its intrinsic stress. Furthermore, the two fibers which are arranged in fixed positions on the stop surfaces are guided and moved by the switching body and a spring structure such that the end surface of that fiber which is arranged in a fixed position and to which the moving fiber is intended to be connected abuts against the end surface of the moving fiber after completion of each switching process, and is held against it by spring force.

In order to compensate for such distance changes, which generally lead to severe attenuation increases at high temperatures or to the fiber ends abutting against one another at low temperatures, switch materials are used which have a thermal coefficient of expansion which is at least similar to that of the fiber which is used, for example as described in the article “Compact Latching-Type Single-Mode-Fiber Switches Fabricated by a Fiber-Micromachining Technique and Their Practical Applications”, IEEE Journal of Selected Topics in Quantum Electronics, Volume 5, No. 1, January/February 1999, pages 36 to 45. However, this greatly restricts the choice of materials for the switch, in particular with regard to the use of polymers. However, polymers have the particular advantage that they allow the use of low-cost precision forming methods.

An optical switch such as this is very expensive and/or large owing to the restricted choice of materials or the comparatively complex mechanism and the mounting on a comparatively complex mechanical actuator.

The invention is thus based on the object of specifying a fiber-optic switching element by means of which a fiber-optic switch or a fiber-optic switch component comprising a number of fiber-optic switches can be constructed, which can be produced easily and at low cost and whose material for the adjustment structure has no influence on the change in the distance between the fibers when temperature changes occur.

According to the invention, this object is achieved by a fiber-optic switching element as claimed in patent claim 1. Advantageous developments of the fiber-optic switching element according to the invention are defined in the subsequent patent claims 2 to 8.

A fiber-optic switch and a fiber-optic switch component according to the invention are specified in the respective patent claims 9 and 11. Advantageous developments are in each case defined in the dependent patent claims 10 and 11.

In contrast to the known optical switches as described above, the fibers according to the invention are mounted at least longitudinally on a mount, which is not necessarily manufactured to be precise and is composed of a material with a thermal coefficient of expansion which corresponds sufficiently well to that of the fibers which are used, so that its lateral alignment is governed by the adjustment structure, while its longitudinal alignment is governed by the mount.

Further advantages of the invention will be explained using the following description of exemplary embodiments of the invention and with reference to the attached figures, in which:

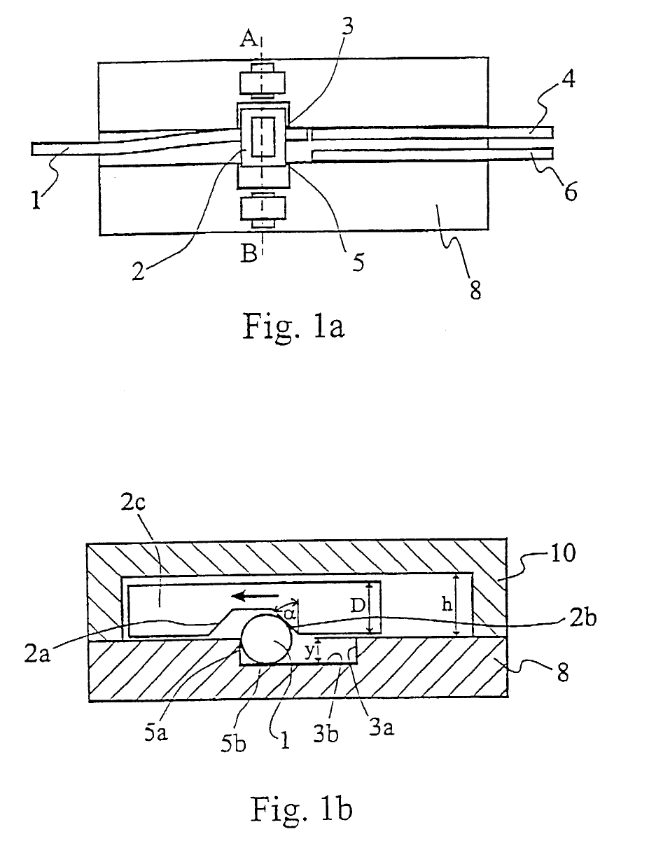

FIG. 1a shows a plan view of a first design variant of an adjustment structure, which can be used for the invention, for a fiber-optic switching element according to the invention;

FIG. 1b shows a section illustration of the adjustment structure illustrated in FIG. 1a;

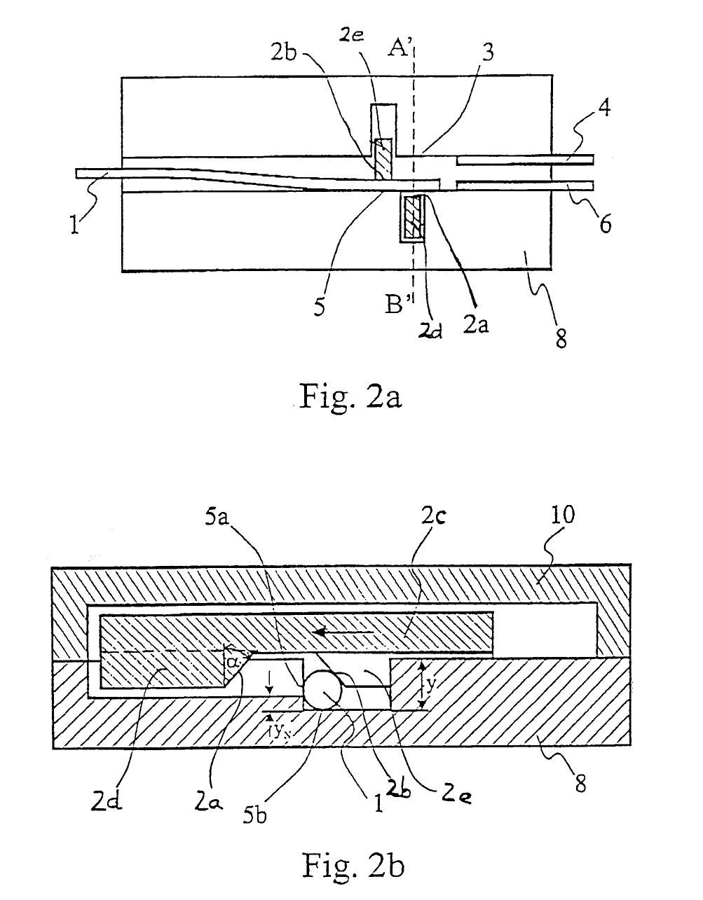

FIG. 2a shows a plan view of a second design variant of an adjustment structure, which can be used for the invention, for a fiber-optic switching element according to the invention;

FIG. 2b shows a section illustration of the adjustment structure illustrated in FIG. 2a;

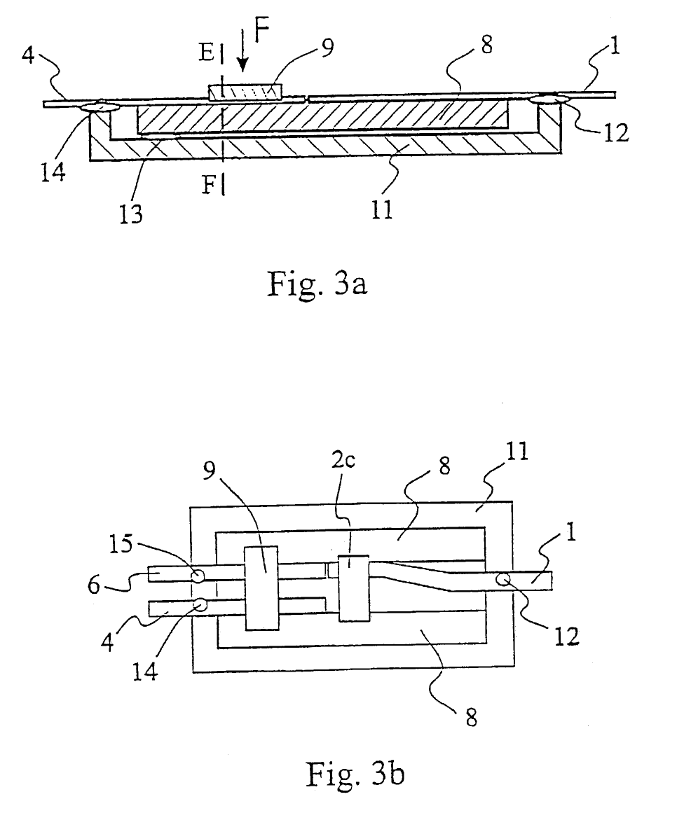

FIGS. 3a and 3b show a longitudinal section and a plan view of a first embodiment of a fiber-optic switching element according to the invention, in order to illustrate the axial and lateral mounting of the optical fibers;

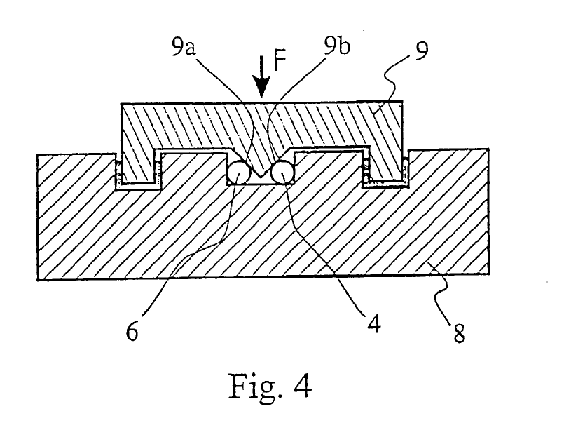

FIG. 4 shows a cross section through a fiber-optic switching element according to the invention, in order to illustrate one advantageous way of laterally mounting the optical fibers which are arranged in fixed positions;

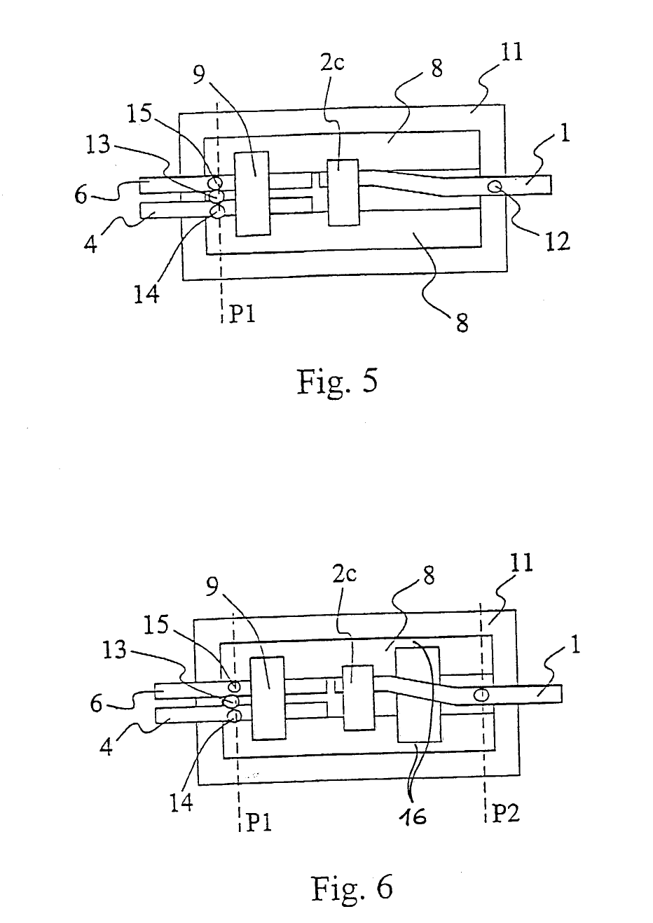

FIG. 5 shows a plan view of a second embodiment of a fiber-optic switching element according to the invention, in order to illustrate the axial and lateral mounting of the optical fibers, and

FIG. 6 shows a plan view of a third embodiment of a fiber-optic switching element according to the invention, in order to illustrate the axial and lateral mounting of the optical fibers.

The preferred embodiments of the invention will be described considering the situation in which the signal which originates from a moving input fiber can be switched alternately between two output fibers which are arranged in fixed positions, that is to say the moving input fiber can be selectively positioned in front of one of two output fibers which are arranged in fixed positions. Both the input fiber and the output fibers may be single-mode or multimode fibers. The fiber-optic switching element according to the invention may, of course, also be designed for a signal flow in the opposite direction, in which one of two input signals which are injected through a respective input fiber which is arranged in a fixed position are passed to a moving output fiber, which can be positioned selectively in front of them.

FIGS. 1a and 1b show a first design variant of an adjustment structure which can be used for the invention and in which the moving input fiber 1 and the output fibers 4, 6 which are arranged in fixed positions are located in a common, approximately rectangular groove in a body 8, which groove is referred to in the following text as a fiber groove, with the input fiber 1 being opposite one of the two output fibers 4, 6, depending on the switching state. The described fixed arrangement of the output fibers relates only to their lateral direction, that is to say to the way they rest on the respective adjustment surfaces.

The signals are transmitted via an end surface coupling, with there being a gap between the fiber end surfaces which is governed by the axial fixing of the fibers. In this case, the fibers may either be cut at right angles, if an index matching liquid is used, or may otherwise be cut inclined at a defined angle. An index matching liquid generally carries out a number of functions. Firstly, it reduces reflections back to the fiber end surfaces of the opposite fibers and, secondly, the widening of the beam which is output from the input fiber 1 in the gap between the input fiber 1 and the corresponding output fiber 4, 6 is reduced. Furthermore, the movement of the fiber in the switch is lubricated by the liquid, as a result of which the wear on the materials which rub against one another in the process is reduced, and the liquid prevents the fibers from which the sleeves have been removed becoming brittle as a consequence of water ingress. If, on the other hand, no index matching liquid is used, then the back reflection is reduced by inclining the fiber end surfaces. However, as a consequence of the increase in the widening of the beam in the gap in this case, the insertion loss is higher than when using an index matching liquid. In this case, both variants may advantageously be combined with one another, in order to obtain particularly low back reflection and low optical attenuation.

The movement of the input fiber 1 from the first switching state in front of the first output fiber 4 which is arranged in a fixed position to the second switching state in front of the second output fiber 6 which is arranged in a fixed position is carried out, for example, electromagnetically, with one switching state or both switching states being stable when no power is being supplied. Power need be supplied only to change the switching state, with a switching body 2 which is not firmly connected to the moving input fiber 1 and comprises a carriage 2c and a permanent magnet connected to it being moved between the two defined positions by means of electromagnetic forces.

The adjustment of the first output fiber 4 as well as the moving input fiber 1 in front of the first output fiber 4 which is arranged in a fixed position is carried out on a first stop 3, and the adjustment of the second output fiber 6 which is arranged in a fixed position as well as the moving input fiber 1 in front of the second output fiber 6 which is arranged in a fixed position is carried out on a second stop 5. The first stop 3 and the second stop 5 are formed by a respective side wall 3a, 5a as well as the base 3b and 5b of the fiber groove which is provided in the body 8. Since the structure of these surfaces which form the respective stop is kept simple, they can be manufactured with high precision at relatively low cost. In this example, the two stops, that is to say the fiber groove which is formed in the body 8 are used as the adjustment structure.

FIG. 1b shows a section illustration of the adjustment structure as shown in FIG. 1a and which can be used for the invention, along the line AB as shown in FIG. 1a, with FIG. 1 showing only the functional principle, but not assemblies which are not significant for this purpose, such as the electromagnetic actuator which is shown in FIG. 1a, where it comprises two electromagnets and the permanent magnet which is arranged on the carriage 2c.

FIG. 1b shows the moving input fiber 1 which is located in the fiber groove and rests on the second stop 5, which comprises the side wall 5a and the base region 5b, adjacent to it, of the fiber groove. In the situation described here, the fiber groove has a depth, that is to say a side wall height, which is less than the fiber diameter but is greater than half the fiber diameter. A carriage 2c of the switching body 2, which has a groove that is flush with the fiber groove and is referred to as a switching groove in the following text, is located resting on the body 8. The carriage 2c can move in the transverse direction with respect to the fiber groove. The switching groove which is located in the carriage 2c has inclined side surfaces 2a, 2b which, in the illustrated situation, are at an angle α=45° to the side walls 3a, 5a and to the base 3b and 5b of the fiber groove which is located in the body 8, such that the switching groove has the cross-sectional shape of a trapezoid, in which the open side facing the body 8 is the longer side. The depth of this switching groove which is formed in the carriage 2c is chosen such that the moving input fiber 1 does not abut against its base. The width of the switching groove is chosen such that it is easy for that part of the moving input fiber 1 which projects out of the fiber groove to find space in the groove.

A cover 10 is placed on the body 8 and forms a cavity with a height h, in which the carriage 2c can move transversely with respect to the fiber groove. The carriage 2c has a height D.

According to the example shown in FIGS. 1a and 1b, the moving input fiber 1 is adjusted on the fiber itself and not on the switching body 2, so that greater precision is achieved. The movement of the carriage 2c in the transverse direction with respect to the fiber groove is constrained only by the fact that the moving fiber 1 rests on the first stop 3 or on the second stop 5, and thus also stops the carriage 2c, which moves the moving fiber 1 and does not strike the side walls of the cavity 10. The carriage 2c per se has to carry out only an imprecise movement, so that there is no need for precise mechanical guidance for the carriage 2c. This acts as a driver, which moves the moving fiber 1 to the respective stop, and presses it against it. Since the side walls 2a, 2b of the switching groove each have a 45° incline, as described above, the force acts on the moving fiber 1 at 45° to the movement direction, so that the fiber is at the same time pressed against one side wall 3a, 5a and against the base 3b and 5b of the fiber groove, that is to say against the complete adjustment structure. In addition, when the moving input fiber 1 is in the stop position, this force acts in such a way that the moving input fiber 1 can be adjusted in two dimensions at the same time by application of the one-dimensional force. However, the invention is not restricted to such an embodiment.

Since the carriage 2c which mechanically moves the moving input fiber 1 is not firmly connected to the input fiber 1, it can be fitted easily, and the fiber is not held longitudinally by the carriage.

FIGS. 2a and 2b show an alternative design variant to that shown in FIGS. 1a and 1b, in which the carriage 2c of the switching body does not run on the surface of the body 8 and has a switching groove, but in which the switching body 2 comprises a carriage 2c with two runners 2d and 2e, which are arranged in axially offset positions with respect to the moving fiber 1 and are guided in a respective guide groove, which is arranged transversely in the body 8 with respect to the fiber groove located therein, although it does not intersect the latter, but is connected to it on only one respective side. FIG. 2b, which shows a section illustration along the line A′-B′ shown in plan view in FIG. 2a, clearly shows that the runner 2d interacts with the side wall 2a and the runner 2e interacts with the side wall 2b, by virtue of their configuration, in a corresponding way to the switching groove shown in FIG. 1b, although this occurs at axially offset positions of the moving input fiber 1. This lateral offset results in the fiber being pressed by the switching body 2 directly against a respective stop 3, 5 and not against an interruption in it, thus avoiding undesirable bending of the fiber.

In this second design variant, the carriage 2c is guided by the runners 2d and 2e in the guide grooves, in order to move the fiber toward a respective stop 3, 5, and to press it against it. These guide grooves do not need to be manufactured with high precision, however, in contrast to the fiber groove, since the switching body 2 is in the form of a driver.

In particular, as in the first design variant as well, this ensures that the switching body does not fix the fiber longitudinally. Any other carriage and switching body shapes are, of course, suitable for the invention which allow lateral but not longitudinal alignment of the moving input fiber 1.

The functional elements of the switch can advantageously be produced by die casting (if made of metal), injection molding (if made of plastic) or other mass-production methods. The simplest processing, whose price is at the same time low and which provides the required precision, is in this case achieved using plastics. However, in the unreinforced state, these exhibit severe, temperature-dependent longitudinal expansion which is different to that of the light guide fibers. Reinforced plastics exhibit this effect to a considerably reduced extent, but the required surface qualities cannot be achieved here. If the entire switch is produced from a material which is subject to severe temperature-dependent longitudinal expansion, then even a minor temperature change frequently results in the switch structure contracting or expanding in such a way that the gap between the moving input fiber 1 and the corresponding output fiber 4, 6, which is arranged in fixed position is reduced or enlarged, as a result of which the attenuation levels achieved may vary severely. Attenuation increases may thus occur at high temperatures, while the fiber ends may abut against one another at low temperatures, with conventional temperature requirements.

According to the invention, this problem can be overcome by the first embodiment according to the invention as shown in FIG. 3a, in which the fibers are not attached laterally and axially to the switch structure per se, that is to say to the adjustment structure formed by the body 8, but to a housing 11 which exhibits less temperature-dependent material expansion, or a temperature-dependent material expansion which corresponds to that of the light guide fibers, such as glass ceramic, glass, ceramic, metal or silicon for glass fiber light guides or suitable polymers for polymer fibers, to which the body 8 of the switching element can likewise be attached. These materials can likewise be produced at very low cost and in large quantities, and the relatively low precision which is achieved is nevertheless sufficient for use as a housing. In FIG. 3a, both the input fiber 1 (which moves within the body 8) and the output fibers 4, 6 which are arranged in fixed positions (laterally within the body 8) are fixed firmly to the housing 11 by adhesive bonds. Both lateral and longitudinal, that is to say axial, fixing may be used here, although longitudinal fixing is necessary. The switch structure which is arranged between the adhesive bonds for the input fiber 1 and for the respective output fibers 4, 6 within this housing 11 is mounted at specific points, for example on the output side, by means of adhesive bonding of the body 8 to the housing 11, as a result of which material stresses resulting from different thermal expansions are kept low.

In order to further illustrate the idea of the invention, FIG. 3b shows a plan view of the arrangement which is shown in the form of a section illustration in FIG. 3a.

The moving (in the body 8) input fiber 1 and the output fibers 4, 6 which are arranged in fixed positions (laterally in the body 8) are fixed laterally within the fiber groove of the body 8 by the carriage 2c and/or the clamping wedge 9, while they are arranged such that they can move longitudinally (or axially, that is to say in the longitudinal direction of the fiber) in the fiber groove. The body 8 is connected to the mount 11 by means of a first fixing 13 which is provided in one position with respect to the fiber longitudinal axes. In the embodiment shown in FIGS. 3a and 3b, this first fixing 13 is, by way of example, provided on that side of the body 8 on which the output fibers 4, 6 are arranged.

The moving (within the body 8) input fiber 1 is connected to the mount 11 by means of a second fixing 12, which is provided in one position with respect to its fiber longitudinal axis, and the output fibers 4, 6, which are arranged in fixed positions (laterally within the body 8), are connected to the mount 11 by means of respective third fixings 14, 15, which are provided in one position with respect to their respective fiber longitudinal axis.

The first, the second and the third fixings 13, 12, 14 and 15 have to ensure axial fixing, according to the invention. However, in the embodiment shown here, additional lateral fixing is not disadvantageous but is advantageous with regard to the configuration of the respective fixing, for example by means of an adhesive bond.

The second fixing 12 is preferably arranged such that it lies on an extension of a line running in the longitudinal direction in the center of the base 3a and 5a of the fiber groove.

The adhesive bonds of the respective fibers to the housing 11 ensure that the fibers are fixed in the axial direction. In the lateral direction, the output fibers 4, 6 are fixed closely in front of the coupling point by means of a clamping wedge 9 within the fiber groove that is located in the body 8. This clamping wedge 9 is, by way of example, firmly adhesively bonded to the body 8, as is shown in FIG. 4, which shows a section along the line EF as shown in FIG. 3a, with the housing 11 not being shown here, since the aim is to illustrate only the functional principle of the clamping wedge 9.

In FIG. 4, it can be seen that the clamping wedge 9 positions the output fibers 4, 6, which are arranged (laterally) in a fixed position in the body 8, on a respective side wall 3a, 5a and the base 3b and 5b of the fiber groove which is located in the body 8, that is to say positioned on the same stops on which the input fiber is positioned in the corresponding switching position. The force is applied by the clamping wedge 9 to the corresponding output fibers 4, 6 in a similar way to that in which the force is applied by the switching body 2 to the moving input fiber 1, with the force in this case being deflected from a direction toward the base of the fiber groove to a direction toward the two surfaces which form the respective stop 3, 5, by means of stop surfaces which are likewise at an angle of 45° to the surfaces 3a, 3b, 5a, 5b which form a respective stop 3, 5.

The clamping wedge 9 clamps the output fibers 4, 6 which are arranged in (laterally) fixed positions in such a way that they rest firmly on the respective stop 3, 5 but can in each case be moved axially, that is to say in their longitudinal direction, on this stop 3, 5.

The axial fixing of the fibers on the housing 11 ensures that the fiber ends of the moving (in the fiber groove in the body 8) input fiber 1 and of the output fibers 4, 6 which are arranged in a (laterally in the fiber groove in the body 8) fixed position face one another with a narrow gap, with the gap having a gap width that is independent of the temperature, owing to the material choice of the housing with respect to the fiber material that is used.

In contrast to the first embodiment which is shown in FIGS. 3a and 3b, in accordance with which the fibers 1, 4, 6 and the adjustment structure that is formed by means of the fiber groove in the body 8 are rigidly mounted at least longitudinally on the mount 11, and the fibers 1, 4, 6 are clamped on the adjustment structure only in the lateral direction, the second embodiment provides for longitudinally and laterally rigid mounting of the input fiber 1 or of the output fibers 4, 6 on the adjustment structure with respect to their respective fiber longitudinal axis in a position in which the adjustment structure is mounted on the mount 11. The opposing fiber or fibers is or are mounted at least longitudinally rigidly on the mount 11, as in the first embodiment.

One design variant of the second embodiment, in which the two output fibers 4, 6 are fixed longitudinally and laterally on the adjustment structure, is shown in FIG. 5. The third fixings 14, 15 for at least axial fixing of the output fibers 4, 6 are provided in the same longitudinal position P1 on the adjustment structure in which the latter is mounted by means of the first fixing 13 on the mount 11.

In contrast to the first embodiment as illustrated in FIGS. 3a and 3b, according to the third embodiment, which is illustrated in FIG. 6, the input fiber 1 and the output fibers 4, 6 are longitudinally and laterally rigidly mounted on the adjustment structure, in each case in a position with respect to their respective fiber longitudinal axis in which the adjustment structure is mounted on the mount 11. The adjustment structure is thus fixed on the mount 11 at two longitudinal positions. Between these two longitudinal fixings of the adjustment structure on the mount 11, this adjustment structure is, however, weakened such that the two parts of the adjustment structure which are connected by the weakened region or thinned region 16 each move with the mount 11 when temperature changes occur.

The third embodiment is shown in FIG. 6. The third fixings 14, 15 for at least axial fixing of the output fibers 4, 6 are provided in the same longitudinal position P1 on the adjustment structure at which a first part of the adjustment structure is mounted on the mount 11 by the first fixing 13, and the second fixing 12 is provided for fixing of the input fiber 1 in the same longitudinal position P2 in which a second part of the adjustment structure, which is connected to the first part of the adjustment structure via the weakened region, is mounted on the mount 11 by means of a fourth fixing.

The weakened region may, by way of example, result from the body 8 being thinned such that the body 8 is not rigid only in the fiber longitudinal direction. A spring structure may also be provided, by way of example, instead of such a weakened region.

A number of switching elements according to the invention may be placed alongside one another or stacked alongside one another, in order to form a multiple switch, in which case the respective switching bodies 2 may be moved by a common actuator which, by way of example, comprises a first electromagnet, a second electromagnet and a number of permanent magnets corresponding to the number of switching bodies and arranged on these switching bodies.

Furthermore, a fiber-optic switch component having a number of actuators can also be formed by one or more fiber-optic switches stacked one above the other or alongside one another.

The fiber-optic switching elements, fiber-optic switches or fiber-optic switch components described above according to the invention can thus be produced at a low price in large quantities by producing their individual parts by die casting, injection molding or similar methods, in which case the assembly process can be automated, since the individual parts need be adjusted only passively. The required high accuracy for the alignment of the moving fiber in front of the fibers which are arranged in fixed positions is achieved by positioning on common straight walls, which are not subject to any temperature-dependent material restriction, and the temperature-dependent longitudinal expansion of the die-cast or injection-molded material is compensated for by the fact that the fibers which are arranged in fixed positions are fixed only laterally on this material and are longitudinally fixed on a mount which has a thermal coefficient of expansion which corresponds to that of the respective fibers. The optional use of an index matching liquid reduces the insertion loss and back reflection, so that attenuation losses are reduced and, furthermore, the movement is lubricated, that is to say the wear at the points which are relevant for positioning is reduced. Furthermore, the moving fiber is protected against becoming brittle. In addition, the fiber end surfaces may also be inclined, in order to further reduce backward reflection.

The fiber-optic switching elements according to the invention result in a lateral and angular alignment accuracy in the micrometer and milliradian ranges. For this purpose, at least the first and the second stop are advantageously manufactured using LIGA or laser LIGA technology.

The exemplary embodiments described so far have described a 1×2 switch whose two stops 3, 5 each have two stop surfaces 3a, 5a and 3b, 5b which are (at least virtually) at right angles to one another. However, the two stop surfaces may also be at a different angle to one another and/or the stops may have a different number of stop surfaces. In addition, there is no need for the two stops to be designed to be identical, either. In a situation such as this, only one corresponding stop surface 2a, 2b of the switching body 2 need be changed and/or arranged so as to achieve a uniform force distribution on the moving input fiber 1, such that it rests on the respective stop in a position defined in the same way as the output fibers 4, 6 which rest there and are arranged such that they are fixed laterally. The teaching according to the invention may also, of course, be used for n×2n switching elements or n×m switching elements with an appropriate arrangement of the fibers, an appropriate configuration of the switching body 2 and of the stops.

It is likewise possible, of course, for all the exemplary embodiments described above to be combined with one another.

1. A fiber-optic switching element, having an adjustment structure (8) for positioning of at least one moving fiber (1) in front of at least one fiber (4, 6), which is arranged in a fixed position, by means of reference surface (3a, 3b, 5a, 5b) , in which case both the moving fiber (1) and the fibers (4, 6) which are arranged in fixed positions are held such that they can be moved longitudinally within the adjustment structure but rest on the reference surfaces (3a, 3b, 5a, 5b), characterized in that a mount (11) with a thermal coefficient of expansion which is comparable to that of the fibers (1, 4, 6) holds the adjustment structure (8) and fixes both the moving fiber (1) and the fibers (4, 6) which are arranged in fixed positions longitudinally, at least as far as their effect is concerned.

2. The fiber-optic switching element as claimed in claim 1, characterized in that the mount (11) is formed from glass ceramic, ceramic or glass.

3. the fiber-optic switching element as claimed in claim 1 or 2, characterized in that the mount (11) is a part of the housing for the fiber-optic switching element.

4. The fiber-optic switching element as claimed in one of claims 1 to 3, characterized in that the adjustment structure (8) and both the moving fiber (1) as well as the fibers (4, 6) which are arranged in fixed positions are each mounted rigidly at one point on the mount (11).

5. The fiber-optic switching element as claimed in one of claims 1 to 3, characterized in that the adjustment structure (8) and the moving fiber (1) are each mounted rigidly at one point on the mount (11)—and the fibers (4, 6) which are arranged in fixed positions are each mounted rigidly at one point at the longitudinal position (P1) on the adjustment structure (11), at which position (P1) the adjustment structure (8) is rigidly mounted on the mount (11), or in that the adjustment structure (8) and the fibers (4, 6) which are arranged in fixed positions are each mounted rigidly at one point on the mount (11) and the moving fiber (1) is mounted rigidly at one point at the longitudinal position on the adjustment structure (8) at which the adjustment structure (8) is mounted rigidly on the mount (11).

6. The fiber-optic switching element as claimed in one of claims 1 to 3, characterized in that the adjustment structure (8) is mounted rigidly at in each case one point in its two longitudinal end regions on the mount (11), and both the moving fiber (1) and the fibers (4, 6) which are arranged in fixed positions are each mounted rigidly at one point at the longitudinal position (P1, P2) on the adjustment structure (8), with the adjustment structure (8) having a thinned region between its two fixings.

7. The fiber-optic switching element as claimed in one of claims 1 to 6, characterized in that the adjustment structure (8) is formed from polymer materials.

8. The fiber-optic switching element as claimed in one of claims 1 to 7, characterized in that the adjustment structure (8) is produced by molding.

9. A fiber-optic switch, characterized by one or more fiber-optic switching elements which are stacked one above the other or alongside one another as claimed in one of claims 1 to 8, which are driven jointly by a common actuator.

10. The fiber-optic switch as claimed in claim 9, characterized in that all the switching elements which are stacked one above the other or alongside one another and the respective associated fibers are fixed on the same mount (11).

11. A fiber-optic switch component, characterized by one or more fiber-optic switches which are stacked one on top of the other or alongside one another, as claimed in claim 9 or 10.

12. The fiber-optic switch component as claimed in claim 11, characterized in that all the switching elements which are stacked one above the other or alongside one another and the respective associated fibers are fixed on the same mount (11).
